(19) United States
(12) Patent Application Publication
(10) Pub. No.: US 2021/0029488 A1
(43) Pub. Date: Jan. 28, 2021

(54) CONTROL DEVICE, COMMUNICATION DEVICE, AND NON-TRANSITORY STORAGE MEDIUM

(71) Applicants: Toyota Jidosha Kabushiki Kaisha, Toyota-shi (JP); Nomura Research Institute, Ltd., Tokyo (JP)

(72) Inventors: Daiki Kaneichi, Nisshin-shi (JP); Naoya Sugita, Tokyo (JP)

(73) Assignees: Toyota Jidosha Kabushiki Kaisha, Toyota-shi Aichi-ken (JP); Nomura Research Institute, Ltd., Tokyo (JP)

(21) Appl. No.: 15/930,004

(22) Filed: May 12, 2020

(30) Foreign Application Priority Data
Jul. 26, 2019 (JP) 2019-138242

(51) Int. Cl. H04W 4/02; G08G 1/0968; G01C 21/34

(52) U.S. Cl. CPC H04W 4/02; G01C 21/34; G08G 1/096811; G08G 1/096844

(57) ABSTRACT

A control device includes a controller configured to determine to dispatch a vehicle to transport at least one user of a plurality of users according to one or more instant messages sent or received between or among the plurality of users.

### CROSS-REFERENCE TO RELATED APPLICATIONS

This application claims priority to Japanese Patent Application No. 2019-138242 filed on Jul. 26, 2019, which is incorporated herein by reference in its entirety including the specification, drawings and abstract.

### BACKGROUND

### 1. Technical Field

The present disclosure relates to a control device, a communication device, and a non-transitory storage medium.

### 2. Description of Related Art

Japanese Unexamined Patent Application Publication No. 2004-341872 (JP 2004-341872 A) describes a technique that dispatches a taxi via a communication network.

### SUMMARY

The vehicle dispatch service of the above related art is not convenient enough.

A technique of the present disclosure improves convenience of a vehicle dispatch service.

A first aspect provides a control device. The control device according to the first aspect includes a controller configured to determine to dispatch a vehicle to transport at least one user of a plurality of users in accordance with one or more instant messages sent or received between or among the plurality of users.

In the control device of the first aspect, the controller may be configured to obtain location information of the at least one user and may be configured to determine, based on the location information of the at least one user, a pickup point, which is a point where the vehicle picks the at least one user up.

In the control device of the first aspect, the controller may be configured such that, when a point indicated by the location information of the at least one user is different from the pickup point, the controller instructs the at least one user to move to the pickup point.

In the control device of the first aspect, the controller may be configured to determine a route for the vehicle which includes the pickup point as a waypoint.

In the control device of the first aspect, the controller may be configured to obtain the location information of the at least one user from an instant message sent by the at least one user.

In the control device of the first aspect, the controller may be configured to obtain location information of two or more users of the plurality of users and may be configured to determine, based on the location information of the two or more users of the plurality of users, whether the two or more users are transported together by the vehicle or separately transported by the vehicle and one or more other vehicles.

In the control device of the first aspect, the controller may be configured such that, when the two or more users are going to be transported together by the vehicle, the controller determines, based on the location information of each user, a pickup point, which is a point where the vehicle picks each of the two or more users up.

In the control device of the first aspect, the controller may be configured such that, when a point indicated by the location information of each of the two or more users is different from the pickup point, the controller instructs each of the two or more users to move to the pickup point.

In the control device of the first aspect, the controller may be configured such that, when there are a plurality of pickup points, the controller obtains location information of the vehicle and determines, based on the location information of the vehicle, a route for the vehicle which includes one of the plurality of pickup points as a first waypoint.

In the control device of the first aspect, the controller may be configured to obtain location information of the vehicle and to determine, based on the location information of the vehicle as well as the location information of each of the two or more users, whether the two or more users are transported together by the vehicle or separately transported by the vehicle and one or more other vehicles.

In the control device of the first aspect, the controller may be configured to obtain the location information of each of the two or more users from an instant message sent by each of the two or more users.

In the control device of the first aspect, the controller may be configured to determine a drop-off point, which is a point where the vehicle drops off the at least one user, in accordance with the one or more instant messages.

In the control device of the first aspect, the controller may be configured such that the controller analyzes content of the one or more instant messages and determines whether a first user, who is the at least one user, is going to visit a second user, who is another user of the plurality of users different from the first user, and in a case where the first user is going to visit the second user, the controller obtains location information of the second user and determines the drop-off point based on the location information of the second user.

In the control device of the first aspect, the controller may be configured such that, when a point indicated by the location information of the second user is different from the drop-off point, the controller instructs the first user to move from the drop-off point.

In the control device of the first aspect, the controller may be configured to determine a route for the vehicle which includes the drop-off point as a destination.

In the control device of the first aspect, the controller may be configured such that the controller analyzes the content of the one or more instant messages and determines whether the vehicle needs to be dispatched, and when the controller determines that the vehicle needs to be dispatched, the controller determines to dispatch the vehicle.

In the control device of the first aspect, the controller may be configured to send an instant message inquiring about dispatch of the vehicle to the at least one user and receive a request from the at least one user.

A second aspect provides a communication device. The communication device according to the second aspect includes a controller configured to perform control to display one or more instant messages sent or received between or among a plurality of users and notify of dispatch of a vehicle that transports at least one user of the plurality of users, which has been determined in accordance with the one or more instant messages.

In the communication device of the second aspect, the controller may be configured to perform control to display an instant message notifying of the dispatch of the vehicle, following the one or more instant messages.

A third aspect provides a non-transitory storage medium. The non-transitory storage medium of the third aspect stores a communication program that is executable by one or more processors and that causes the one or more processors to perform functions. The functions include: performing control to cause a computer to display one or more instant messages sent or received between or among a plurality of users; and notifying of dispatch of a vehicle that transports at least one user of the plurality of users, which has been determined in accordance with the one or more instant messages.

According to the above aspects, convenience of a vehicle dispatch service is improved.

### BRIEF DESCRIPTION OF THE DRAWINGS

Features, advantages, and technical and industrial significance of exemplary embodiments will be described below with reference to the accompanying drawings, in which like signs denote like elements, and wherein:

FIG. 1 illustrates the configuration of a cooperation system according to an embodiment;

FIG. 2 is a block diagram illustrating the configuration of a communication device according to the embodiment;

FIG. 3 is a block diagram illustrating the configuration of a control device according to the embodiment;

FIG. 4 is a block diagram illustrating the configuration of an information processing device according to the embodiment;

FIG. 5 is a block diagram illustrating the configuration of an on-board device according to the embodiment;

FIG. 6 illustrates operation of the cooperation system according to the embodiment;

FIG. 7 illustrates operation of the cooperation system according to the embodiment;

and

FIG. 8 illustrates an example of the screen of a terminal according to the embodiment.

### DETAILED DESCRIPTION OF EMBODIMENTS

An embodiment will be described below with reference to the accompanying drawings.

The same or corresponding portions are denoted with the same reference signs throughout the figures. In the description of the embodiment, description of the same or corresponding portions will be omitted or simplified as appropriate.

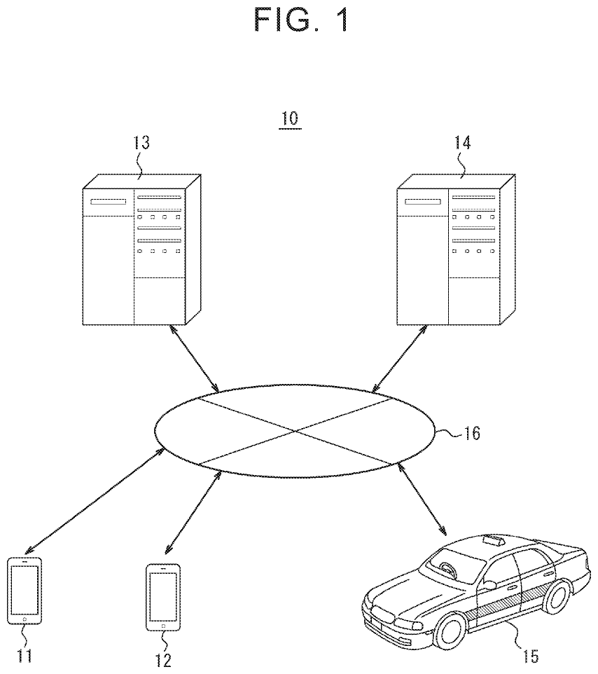

The configuration of a cooperation system 10 according to the present embodiment will be described with reference to FIG. 1.

The cooperation system 10 includes at least two terminals such as a terminal 11 of a user U1 and a terminal 12 of a user U2, at least one SNS server 13, at least one vehicle dispatch server 14, and at least one vehicle 15. “SNS” is an abbreviation for social networking service.

Each terminal can communicate with the SNS server 13 via a network 16 such as a mobile communication network and the Internet. Each terminal may be able to communicate with other terminal via the network 16. Each terminal may be able to communicate with the vehicle dispatch server 14 and/or the vehicle 15 via the network 16.

The SNS server 13 can communicate not only with each terminal but also with the vehicle dispatch server 14 via the network 16. The SNS server 13 may be able to communicate with the vehicle 15 via the network 16.

The vehicle dispatch server 14 can communicate not only with the SNS server 13 but also with the vehicle 15 via the network 16.

In the present embodiment, the vehicle 15 is a taxi. However, the vehicle 15 may be an automobile other than a taxi, such as an on-demand bus, as long as it can transport at least one user such as the user U1 or the user U2. The vehicle 15 is any type of automobile such as, e.g., a gasoline vehicle, a diesel vehicle, an HV, a PHV, an EV, or an FCV. “HV” is an abbreviation for hybrid vehicle. “PHV” is an abbreviation for plug-in hybrid vehicle. “EV” is an abbreviation for electric vehicle. “FCV” is an abbreviation for fuel cell vehicle. In the present embodiment, the vehicle 15 is driven by a driver. However, driving of the vehicle 15 may be automated at a desired level. For example, the level of driving automation is one of levels 1 to 5 defined by SAE. “SAE” is an abbreviation for the Society of Automotive Engineers. The vehicle 15 may be a MaaS-dedicated vehicle. “MaaS” is an abbreviation for Mobility as a Service.

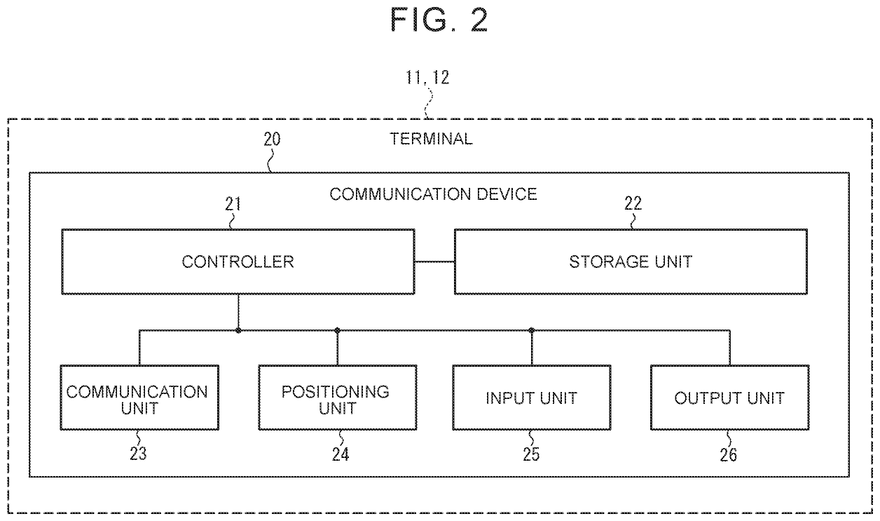

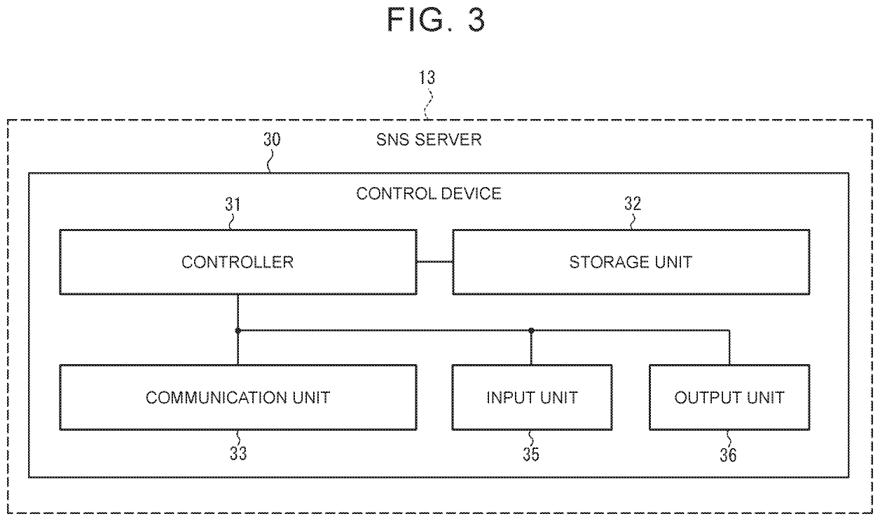

An overview of the present embodiment will be provided with reference to FIGS. 2 and 3.

A control device 30 configured as the SNS server 13 determines to dispatch the vehicle 15 that transports at least one of a plurality of users, according to one or more instant messages sent or received between or among the plurality of users. A communication device 20 configured as the terminal 11 or the terminal 12 displays one or more instant messages sent or received between or among a plurality of users and notifies of dispatch of the vehicle 15 that transports at least one of the plurality of users determined according to the one or more instant messages.

In the present embodiment, the vehicle 15 can be dispatched according to one or more instant messages sent or received between or among a plurality of users. Convenience of the vehicle dispatch service is thus improved.

In the present embodiment, the control device 30 determines to dispatch the vehicle 15 according to an instant message(s) sent on SNS. Specifically, the control device 30 reserves a vehicle to be dispatched and determines a route based on the locations of a plurality of people joining the chat, the destination, the locations of taxis, etc. The control device 30 may analyze the content of the chat conversation and propose a method of transportation. The control device 30 may propose not only a taxi but also a multimodal route that combines various methods of transport such as walking, bicycle, bus, rental car, private car, railway, or airplane. The control device 30 may cause a taxi service provider bot to interrupt the chat. The control device 30 may set the location of the chat partner to the destination.

The configuration of the communication device 20 according to the present embodiment will be described with reference to FIG. 2.

In the present embodiment, the communication device 20 is configured as the terminal 11 or the terminal 12. The communication device 20 is, e.g., a mobile phone, a smartphone, a tablet, or a PC. “PC” is an abbreviation for personal computer.

The communication device 20 includes a controller 21, a storage unit 22, a communication unit 23, a positioning unit 24, an input unit 25, and an output unit 26.

The controller 21 includes one or more processors, one or more dedicated circuits, or a combination thereof. The processor is a general-purpose processor such as a CPU or a dedicated processor that specializes in specific processing. “CPU” is an abbreviation for central processing unit. The dedicated circuit is, e.g., an FPGA or an ASIC. “FPGA” is an abbreviation for field-programmable gate array. “ASIC” is an abbreviation for application specific integrated circuit. The controller 21 performs information processing related to operation of the communication device 20 while controlling each unit of the communication device 20.

The storage unit 22 includes one or more semiconductor memories, one or more magnetic memories, one or more optical memories, or a combination of at least two of these. The semiconductor memory is, e.g., a RAM or a ROM. “RAM” is an abbreviation for random access memory. “ROM” is an abbreviation for read only memory. The RAM is, e.g., an SRAM or a DRAM. “SRAM” is an abbreviation for static random access memory. “DRAM” is an abbreviation for dynamic random access memory. The ROM is, e.g., an EEPROM. “EEPROM” is an abbreviation for electrically erasable programmable read only memory. The storage unit 22 functions as, e.g., a main storage device, an auxiliary storage device, or a cache memory. The storage unit 22 stores information to be used for operation of the communication device 20 and information obtained by operation of the communication device 20.

The communication unit 23 includes one or more communication interfaces. The communication interface is, e.g., an interface according to a mobile communication standard such as LTE, 4G, or 5G or a LAN interface. “LTE” is an abbreviation for Long Term Evolution. “4G” is an abbreviation for 4th generation. “5G” is an abbreviation for 5th generation. “LAN” is an abbreviation for local area network. The communication unit 23 receives information to be used for operation of the communication device 20 and sends information obtained by operation of the communication device 20.

The positioning unit 24 includes one or more GNSS receivers. “GNSS” is an abbreviation for global navigation satellite system. The GNSS includes, e.g., at least one of GPS, QZSS, GLONASS, and Galileo. “GPS” is an abbreviation for Global Positioning System. “QZSS” is an abbreviation for Quasi-Zenith Satellite System. QZSS satellites are called quasi-zenith satellites. “GLONASS” is an abbreviation for Global Navigation Satellite System. The positioning unit 24 obtains location information of the terminal 11 or the terminal 12 as location information of the user U1 or the user U2.

The input unit 25 includes one or more input interfaces. The input interface is, e.g., a physical key, a capacitance key, a pointing device, a touch screen integrated with a display, or a microphone. The input unit 25 receives an operation of inputting information to be used for operation of the communication device 20.

The output unit 26 includes one or more output interfaces. The output interface is, e.g., a display or a speaker. The display is, e.g., an LCD or an organic EL display. “LCD” is an abbreviation for liquid crystal display. “EL” is an abbreviation for electroluminescence. The output unit 26 outputs information obtained by operation of the communication device 20.

Functions of the communication device 20 are carried out by executing a communication program according to the present embodiment by the processor included in the controller 21. That is, the functions of the communication device 20 are carried out by software. The communication program is a program for causing a computer to perform processing of steps included in operation of the communication device 20 so that the computer carries out functions corresponding to the processing of the steps. That is, the communication program is a program for causing the computer to function as the communication device 20.

The program can be recorded on a computer-readable recording medium. The computer-readable recording medium is, e.g., a magnetic recording device, an optical disk, a magnetooptical recording medium, or a semiconductor memory. The program is distributed by, e.g., selling, transferring, or lending a portable recording medium, such as a DVD or a CD-ROM, having the program recorded thereon. “DVD” is an abbreviation for digital versatile disc. “CD-ROM” is an abbreviation for compact disc read only memory. The program may be stored in the storage of a server and distributed by transferring the program from the server to other computers. The program may be provided as a program product.

For example, the computer first stores the program recorded on the portable recording medium or the program transferred from the server in a main storage device. The computer then reads the program stored in the main storage device by a processor and performs processing according to the read program by the processor. The computer may read the program directly from the portable recording medium and perform the processing according to the program. The computer may perform the processing according to the received program every time the program is transferred from the server to the computer. The program may not be transferred from the server to the computer and the processing may be performed using what is called an ASP service, namely the functions may be carried out by merely sending execution instructions and receiving results. “ASP” is an abbreviation for application service provider. The program includes information equivalent to the program, which is to be used for processing by an electronic computer. For example, data that is not a direct instruction to a computer but has properties that define processing of the computer falls under the “information equivalent to the program.”

A part or all of the functions of the communication device 20 may be carried out by the dedicated circuit included in the controller 21. That is, a part or all of the functions of the communication device 20 may be carried out by hardware.

The configuration of the control device 30 according to the present embodiment will be described with reference to FIG. 3.

In the present embodiment, the control device 30 is configured as the SNS server 13. The SNS server 13 is, e.g., a server that belongs to a cloud computing system or other computing system.

The control device 30 includes a controller 31, a storage unit 32, a communication unit 33, an input unit 35, and an output unit 36.

The controller 31 includes one or more processors, one or more dedicated circuits, or a combination thereof. The processor is a general-purpose processor such as a CPU or a dedicated processor that specializes in specific processing. The dedicated circuit is, e.g., an FPGA or an ASIC. The controller 31 performs information processing related to operation of the control device 30 while controlling each unit of the control device 30.

The storage unit 32 includes one or more semiconductor memories, one or more magnetic memories, one or more optical memories, or a combination of at least two of these. The semiconductor memory is, e.g., a RAM or a ROM. The RAM is, e.g., an SRAM or a DRAM. The ROM is, e.g., an EEPROM. The storage unit 32 functions as, e.g., a main storage device, an auxiliary storage device, or a cache memory. The storage unit 32 stores information to be used for operation of the control device 30 and information obtained by operation of the control device 30.

The communication unit 33 includes one or more communication interfaces. The communication interface is, e.g., a LAN interface. The communication unit 33 receives information to be used for operation of the control device 30 and sends information obtained by operation of the control device 30.

The input unit 35 includes one or more input interfaces. The input interface is, e.g., a physical key, a capacitance key, a pointing device, a touch screen integrated with a display, or a microphone. The input unit 35 receives an operation of inputting information to be used for operation of the control device 30.

The output unit 36 includes one or more output interfaces. The output interface is, e.g., a display or a speaker. The display is, e.g., an LCD or an organic EL display. The output unit 36 outputs information obtained by operation of the control device 30.

Functions of the control device 30 are carried out by executing a control program according to the present embodiment by the processor included in the controller 31. That is, the functions of the control device 30 are carried out by software. The control program is a program for causing a computer to perform processing of steps included in operation of the control device 30 so that the computer carries out functions corresponding to the processing of the steps. That is, the control program is a program for causing the computer to function as the control device 30.

A part or all of the functions of the control device 30 may be carried out by the dedicated circuit included in the controller 31. That is, a part or all of the functions of the control device 30 may be carried out by hardware.

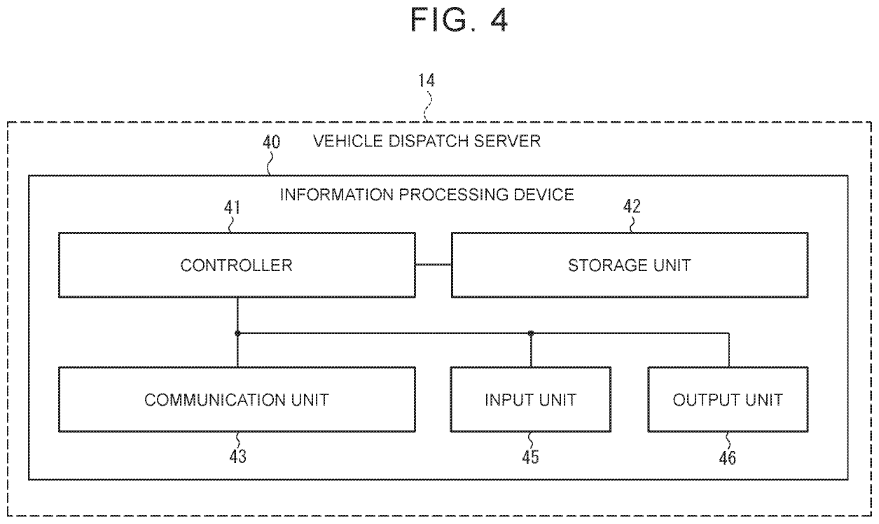

The configuration of an information processing device 40 according to the present embodiment will be described with reference to FIG. 4.

In the present embodiment, the information processing device 40 is configured as the vehicle dispatch server 14. The vehicle dispatch server 14 is, e.g., a server that belongs to a cloud computing system or other computing system.

The information processing device 40 includes a controller 41, a storage unit 42, a communication unit 43, an input unit 45, and an output unit 46.

The controller 41 includes one or more processors, one or more dedicated circuits, or a combination thereof. The processor is a general-purpose processor such as a CPU or a dedicated processor that specializes in specific processing. The dedicated circuit is, e.g., an FPGA or an ASIC. The controller 41 performs information processing related to operation of the information processing device 40 while controlling each unit of the information processing device 40.

The storage unit 42 includes one or more semiconductor memories, one or more magnetic memories, one or more optical memories, or a combination of at least two of these. The semiconductor memory is, e.g., a RAM or a ROM. The RAM is, e.g., an SRAM or a DRAM. The ROM is, e.g., an EEPROM. The storage unit 42 functions as, e.g., a main storage device, an auxiliary storage device, or a cache memory. The storage unit 42 stores information to be used for operation of the information processing device 40 and information obtained by operation of the information processing device 40.

The communication unit 43 includes one or more communication interfaces. The communication interface is, e.g., a LAN interface. The communication unit 43 receives information to be used for operation of the information processing device 40 and sends information obtained by operation of the information processing device 40.

The input unit 45 includes one or more input interfaces. The input interface is, e.g., a physical key, a capacitance key, a pointing device, a touch screen integrated with a display, or a microphone. The input unit 45 receives an operation of inputting information to be used for operation of the information processing device 40.

The output unit 46 includes one or more output interfaces. The output interface is, e.g., a display or a speaker. The display is, e.g., an LCD or an organic EL display. The output unit 46 outputs information obtained by operation of the information processing device 40.

Functions of the information processing device 40 are carried out by executing an information processing program according to the present embodiment by the processor included in the controller 41. That is, the functions of information processing device 40 are carried out by software. The information processing program is a program for causing a computer to perform processing of steps included in operation of the information processing device 40 so that the computer carries out functions corresponding to the processing of the steps. That is, the information processing program is a program for causing the computer to function as the information processing device 40.

A part or all of the functions of the information processing device 40 may be carried out by the dedicated circuit included in the controller 41. That is, a part or all of the functions of the information processing device 40 may be carried out by hardware.

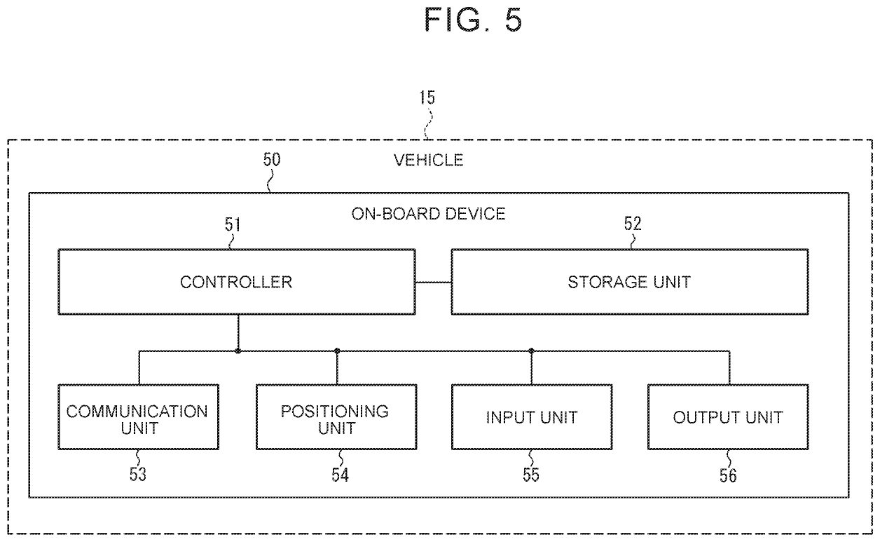

The configuration of an on-board device 50 according to the present embodiment will be described with reference to FIG. 5.

In the present embodiment, the on-board device 50 is mounted on the vehicle 15. The on-board device 50 is, e.g., a car navigation system, a mobile phone, a smartphone, a tablet, or a PC.

The on-board device 50 includes a controller 51, a storage unit 52, a communication unit 53, a positioning unit 54, an input unit 55, and an output unit 56.

The controller 51 includes one or more processors, one or more dedicated circuits, or a combination thereof. The processor is a general-purpose processor such as a CPU or a dedicated processor that specializes in specific processing. The dedicated circuit is, e.g., an FPGA or an ASIC. The controller 51 performs information processing related to operation of the on-board device 50 while controlling each unit of the on-board device 50.

The storage unit 52 includes one or more semiconductor memories, one or more magnetic memories, one or more optical memories, or a combination of at least two of these. The semiconductor memory is, e.g., a RAM or a ROM. The RAM is, e.g., an SRAM or a DRAM. The ROM is, e.g., an EEPROM. The storage unit 52 functions as, e.g., a main storage device, an auxiliary storage device, or a cache memory. The storage unit 52 stores information to be used for operation of the on-board device 50 and information obtained by operation of the on-board device 50.

The communication unit 53 includes one or more communication interfaces. The communication interface is, e.g., an interface according to a mobile communication standard such as LTE, 4G, or 5G. The communication unit 53 receives information to be used for operation of the on-board device 50 and sends information obtained by operation of the on-board device 50.

The positioning unit 54 includes one or more GNSS receivers. The GNSS includes, e.g., at least one of GPS, QZSS, GLONASS, and Galileo. The positioning unit 54 obtains location information of the vehicle 15.

The input unit 55 includes one or more input interfaces. The input interface is, e.g., a physical key, a capacitance key, a pointing device, a touch screen integrated with a display, or a microphone. The input unit 55 receives an operation of inputting information to be used for operation of the on-board device 50.

The output unit 56 includes one or more output interfaces. The output interface is, e.g., a display or a speaker. The display is, e.g., an LCD or an organic EL display. The output unit 56 outputs information obtained by operation of the on-board device 50.

Functions of the on-board device 50 are carried out by executing a vehicle program according to the present embodiment by the processor included in the controller 51. That is, the functions of the on-board device 50 are carried out by software. The vehicle program is a program for causing a computer to perform processing of steps included in operation of the on-board device 50 so that the computer carries out functions corresponding to the processing of the steps. That is, the vehicle program is a program for causing the computer to function as the on-board device 50.

A part or all of the functions of the on-board device 50 may be carried out by the dedicated circuit included in the controller 51. That is, a part or all of the functions of the on-board device 50 may be carried out by hardware.

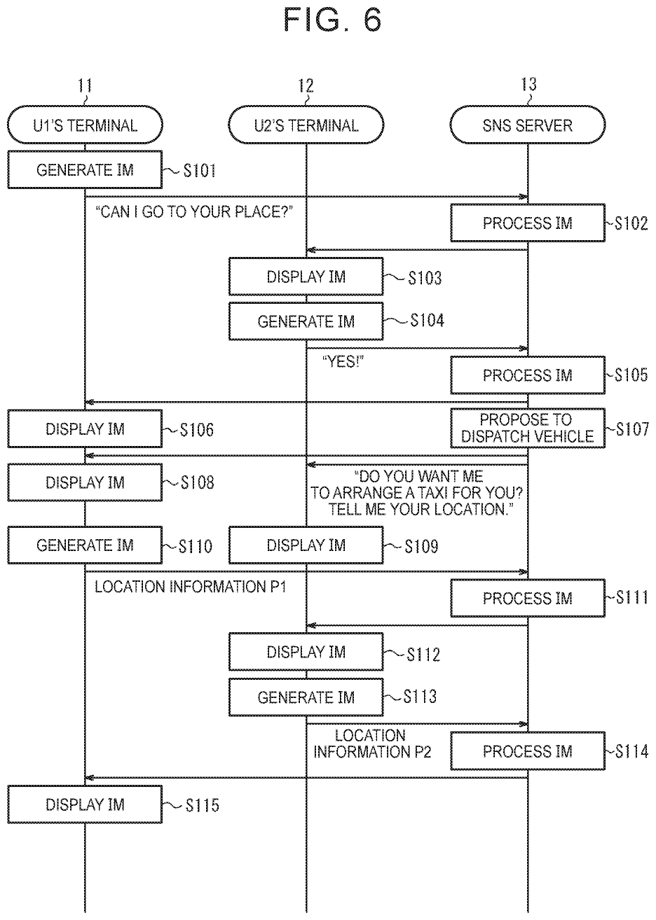

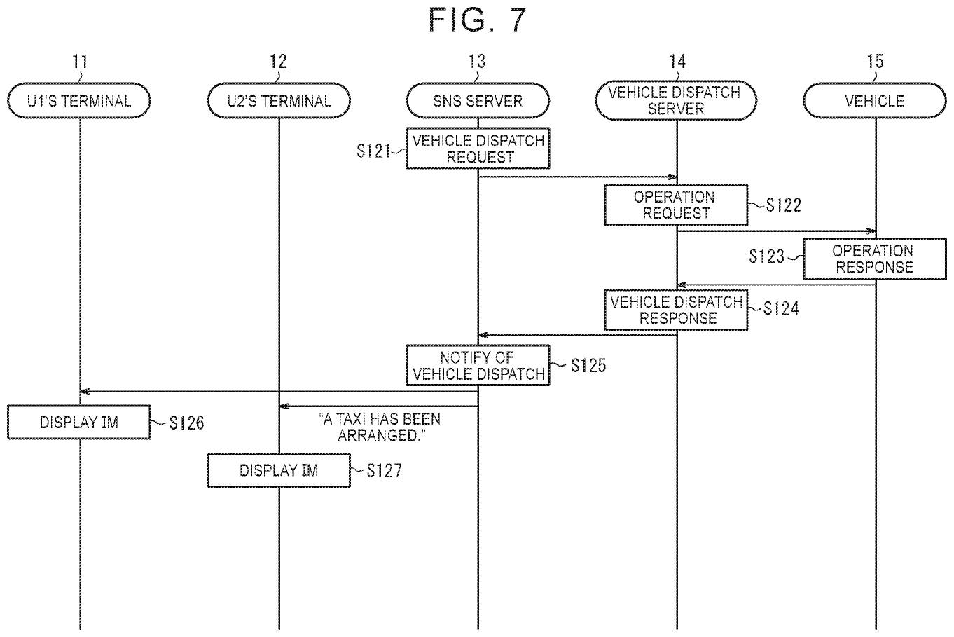

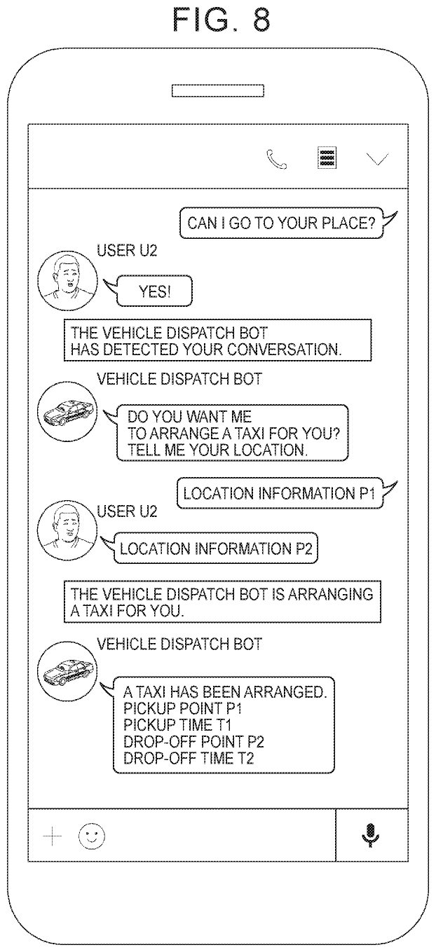

Operation of the cooperation system 10 according to the present embodiment will be described with reference to FIGS. 6, 7, and 8. This operation corresponds to a vehicle dispatch method according to the present embodiment. In FIGS. 6 and 7, “IM” means an instant message. FIG. 8 shows an example of the screen of the terminal 11 of the user U1.

As an example, it is assumed that the user U1 and the user U2 send instant messages to each other to chat on SNS.

In step S101, the controller 21 of the communication device 20 corresponding to the terminal 11 of the user U1 receives via the input unit 25 an operation of the user U1 entering a text to be sent to the user U2. The controller 21 generates an instant message containing the entered text. The controller 21 sends the generated instant message to the control device 30 corresponding to the SNS server 13 via the communication unit 23.

In this example, the user U1 enters a text “Can I go to your place?” to the terminal 11. The controller 21 of the terminal 11 sends an instant message containing the entered text to the SNS server 13.

In step S102, the controller 31 of the control device 30 corresponding to the SNS server 13 receives via the communication unit 33 the instant message sent in step S101. The controller 31 not only sends the received instant message to the communication device 20 corresponding to the terminal 12 of the user U2 via the communication unit 33 but also processes the received instant message. Specifically, the controller 31 not only processes the received instant message in a manner similar to that of conventional SNS chat but also analyzes the content of the received instant message and determines whether a vehicle needs to be dispatched to transport the user U1. For example, the controller 31 determines whether a vehicle needs to be dispatched to transport the user U1 by analyzing the content of one or more instant messages sent or received between the user U1 and the user U2 including the received instant message and determining whether the user U1 is going to visit the user U2.

In this example, the controller 31 of the SNS server 13 transfers the instant message containing the text “Can I go to your place?” from the terminal 11 of the user U1 to the terminal 12 of the user U2. Whether or not the user U1 is going to visit the user U2 cannot be determined by the message “Can I go to your place?” only. The controller 31 of the SNS server 13 therefore determines that no vehicle need be dispatched to transport the user U1.

In step S103, the controller 21 of the communication device 20 corresponding to the terminal 12 of the user U2 receives via the communication unit 23 the instant message sent in step S102. The controller 21 displays the received instant message on the screen via the output unit 26.

In this example, the controller 21 of the terminal 12 of the user U2 receives the instant message containing the text “Can I go to your place?” from the SNS server 13. The controller 21 of the terminal 12 displays the received instant message to the user U2.

In step S104, the controller 21 of the communication device 20 corresponding to the terminal 12 of the user U2 receives via the input unit 25 an operation of the user U2 entering a text to be sent to the user U1. The controller 21 generates an instant message containing the entered text. The controller 21 sends the generated instant message to the control device 30 corresponding to the SNS server 13 via the communication unit 23.

In this example, the user U2 enters a text “Yes!” to the terminal 12. The controller 21 of the terminal 12 sends an instant message containing the entered text to the SNS server 13.

In step S105, the controller 31 of the control device 30 corresponding to SNS server 13 receives the instant message send in step S104 via the communication unit 33. The controller 31 not only sends the received instant message to the communication device 20 corresponding to the terminal 11 of the user U1 via the communication unit 33 but also processes the received instant message. Specifically, the controller 31 not only processes the received instant message in a manner similar to that of the conventional SNS chat but also analyzes the content of the received instant message and determines whether a vehicle needs to be dispatched to transport the user U1 in a manner similar to that of step S102.

In this example, the controller 31 of the SNS server 13 transfers the instant message containing the text “Yes!” from the terminal 12 of the user U2 to the terminal 11 of the user U1. Since the message “Yes!” is sent in response to the message “Can I go to your place?,” it can be determined that the user U1 is going to visit the user U2. The controller 31 of the SNS server 13 therefore determines that a vehicle needs to be dispatched to transport the user U1. The controller 31 of the SNS server 13 displays a system message such as “The vehicle dispatch bot has detected your conversation” on both the terminal 11 of the user U1 and the terminal 12 of the user U2. With such a system message being displayed, a proposal to dispatch a vehicle to transport the user U1 will feel less abrupt to the users U1 and U2.

In step S106, the controller 21 of the communication device 20 corresponding to the terminal 11 of the user U1 receives via the communication unit 23 the instant message sent in step S105. The controller 21 displays the received instant message on the screen via the output unit 26.

In this example, the controller 21 of the terminal 11 receives the instant message containing the text “Yes!” from the SNS server 13. The controller 21 of the terminal 11 displays the received instant message to the user U1.

When the controller 31 of the control device 30 corresponding to the SNS server 13 determines in step S105 that a vehicle needs to be dispatched to transport the user U1, the controller 31 generates in step S107 an instant message that proposes to dispatch a vehicle to transport the user U1. The controller 31 sends the generated instant message to both the communication device 20 corresponding to the terminal 11 of the user U1 and the communication device 20 corresponding to the terminal 12 of the user U2 via the communication unit 33.

In this example, the controller 31 of the SNS server 13 sends an instant message containing a text “Do you want me to arrange a taxi for you? Tell me your location.” to both the terminal 11 of the user U1 and the terminal 12 of the user U2.

In step S108, the controller 21 of the communication device 20 corresponding to the terminal 11 of the user U1 receives via the communication unit 23 the instant message sent in step S107. The controller 21 displays the received instant message on the screen via the output unit 26.

In this example, the controller 21 of the terminal 11 receives the instant message containing the text “Do you want me to arrange a taxi for you? Tell me your location.” from the SNS server 13. The controller 21 of the terminal 11 displays the received instant message to the user U1.

In step S109, the controller 21 of the communication device 20 corresponding to the terminal 12 of the user U2 receives via the communication unit 23 the instant message sent in step S107. The controller 21 displays the received instant message on the screen via the output unit 26.

In this example, the controller 21 of the terminal 12 receives the instant message containing the text “Do you want me to arrange a taxi for you? Tell me your location.” from the SNS server 13. The controller 21 of the terminal 12 displays the received instant message to the user U2.

In step S110, the controller 21 of the communication device 20 corresponding to the terminal 11 of the user U1 receives via the input unit 25 an operation of the user U1 entering location information P1 of the user U1. The location information P1 may be directly input as a text such as an address by an operation of the user U1 or may be obtained by the positioning unit 24 according to an operation of the user U1 and input by the positioning unit 24 as data such as two-dimensional coordinates or three-dimensional coordinates. The controller 21 generates an instant message containing the input location information P1. The controller 21 sends the generated instant message to the control device 30 corresponding to the SNS server 13 via the communication unit 23.

In this example, the controller 21 of the terminal 11 sends to the SNS server 13 an instant message containing as the location information P1 the coordinates of the point where the user U1 is located.

In step S111, the controller 31 of the control device 30 corresponding to the SNS server 13 receives via the communication unit 33 the instant message sent in step S110. The controller 31 not only sends the received instant message to the communication device 20 corresponding to the terminal 12 of the user U2 via the communication unit 33 but also processes the received instant message. Specifically, the controller 31 not only processes the received instant message in a manner similar to that of the conventional SNS chat but also stores the location information P1 contained in the received instant message in the storage unit 32.

In this example, the controller 31 of the SNS server 13 transfers the instant message containing as the location information P1 the coordinates of the point where the user U1 is located from the terminal 11 of the user U1 to the terminal 12 of the user U2.

In step S112, the controller 21 of the communication device 20 corresponding to the terminal 12 of the user U2 receives via the communication unit 23 the instant message sent in step S111. The controller 21 displays the received instant message on the screen via the output unit 26.

In this example, the controller 21 of the terminal 12 of the user U2 receives from the SNS server 13 the instant message containing as the location information P1 the coordinates of the point where the user U1 is located. The controller 21 of the terminal 12 displays the received instant message to the user U2.

In step S113, the controller 21 of the communication device 20 corresponding to the terminal 12 of the user U2 receives via the input unit 25 an operation of the user U2 entering location information P2 of the user U2. The location information P2 may be directly input as a text such as an address by an operation of the user U2 or may be obtained by the positioning unit 24 according to an operation of the user U2 and input by the positioning unit 24 as data such as two-dimensional coordinates or three-dimensional coordinates. The controller 21 generates an instant message containing the input location information P2. The controller 21 sends the generated instant message to the control device 30 corresponding to the SNS server 13 via the communication unit 23.

In this example, the controller 21 of the terminal 12 sends to the SNS server 13 an instant message containing as the location information P2 the coordinates of the point where the user U2 is located.

In step S114, the controller 31 of the control device 30 corresponding to the SNS server 13 receives via the communication unit 33 the instant message sent in step S113. The controller 31 not only sends the received instant message to the communication device 20 corresponding to the terminal 11 of the user U1 via the communication unit 33 but also processes the received instant message. Specifically, the controller 31 not only processes the received instant message in a manner similar to that of the conventional SNS chat but also stores the location information P2 contained in the received instant message in the storage unit 32.

In this example, the controller 31 of the SNS server 13 transfers the instant message containing as the location information P2 the coordinates of the point where the user U2 is located from the terminal 12 of the user U2 to the terminal 11 of the user U1.

In step S115, the controller 21 of the communication device 20 corresponding to the terminal 11 of the user U1 receives via the communication unit 23 the instant message sent in step S114. The controller 21 displays the received instant message on the screen via the output unit 26.

In this example, the controller 21 of the terminal 11 of the user U1 receives from the SNS server 13 the instant message containing as the location information P2 the coordinates of the point where the user U2 is located. The controller 21 of the terminal 11 displays the received instant message to the user U1.

In step S121, the controller 31 of the control device 30 corresponding to the SNS server 13 obtains the location information P1 stored in the storage unit 32 in step S111 and the location information P2 stored in the storage unit 32 in step S114. The controller 31 generates a vehicle dispatch request containing the obtained location information P1 as location information indicating a pickup point and containing the obtained location information P2 as location information indicating a drop-off point. The pickup point is a point where the vehicle 15 picks the user U1 up. The drop-off point is a point where the vehicle 15 drops the user U1 off. The controller 31 sends the generated dispatch request to the information processing device 40 corresponding to the vehicle dispatch server 14 via the communication unit 33.

In this example, the controller 31 of the SNS server 13 sends to the vehicle dispatch server 14 a vehicle dispatch request containing the coordinates of the point where the user U1 is located as the location information of the pickup point and containing the coordinates of the point where the user U2 is located as the location information of the drop-off point.

In step S122, the controller 41 of the information processing device 40 corresponding to the vehicle dispatch server 14 receives via the communication unit 43 the vehicle dispatch request sent in step S121. The controller 41 generates an operation request corresponding to the received vehicle dispatch request. The controller 41 sends the generated operation request to the on-board device 50 mounted on the vehicle 15 via the communication unit 43.

In this example, the controller 41 of the vehicle dispatch server 14 sends to the vehicle 15 an operation request containing the same location information of the pickup point and the same location information of the drop-off point as those in the vehicle dispatch request.

In step S123, the controller 51 of the on-board device 50 mounted on the vehicle 15 receives via the communication unit 53 the operation request sent in step S122. The controller 51 displays the location information of the pickup point and the location information of the drop-off point, which are contained in the received operation request, on the screen via the output unit 56. The controller 51 receives via the input unit 55 an operation of the driver of the vehicle 15 answering whether the vehicle 15 is available for the operation request. The controller 51 generates an operation response indicating the driver's answer, namely indicating whether the vehicle 15 is available for the operation request. The controller 51 sends the generated operation response to the information processing device 40 corresponding to the vehicle dispatch server 14 via the communication unit 53.

In this example, the driver of the vehicle 15 answers that the vehicle 15 is available for the operation request and enters a pickup time and a drop-off time to the vehicle 15. The pickup time is the time the vehicle 15 picks the user U1 up. The drop-off time is the time the vehicle 15 drops the user U1 off, namely the time the vehicle 15 is expected to arrive at the destination. The vehicle 15 sends to the vehicle dispatch server 14 an operation response indicating both the driver's answer that the vehicle 15 is available for the operation request and the entered pickup and drop-off times.

In step S124, the controller 41 of the information processing device 40 corresponding to the vehicle dispatch server 14 receives via the communication unit 43 the operation response sent in step S123. The controller 41 generates a vehicle dispatch response corresponding to the received operation response. The controller 41 sends the generated vehicle dispatch response to the control device 30 corresponding to the SNS server 13 via the communication unit 43.

In this example, the controller 41 of the vehicle dispatch server 14 sends to the SNS server 13 a vehicle dispatch response indicating both the answer that the vehicle 15 is available for the operation request and the pickup and drop-off times like the operation response.

In step S125, the controller 31 of the control device 30 corresponding to the SNS server 13 receives via the communication unit 33 the vehicle dispatch response sent in step S124. When the controller 31 receives the vehicle dispatch response indicating the answer that the vehicle 15 is available to be dispatched to transport the user U1, the controller 31 generates an instant message that notifies of dispatch of the vehicle 15. The controller 31 sends the generated instant message to both the communication device 20 corresponding to the terminal 11 of the user U1 and the communication device 20 corresponding to the terminal 12 of the user U2 via the communication unit 33.

In this example, the controller 31 of the SNS server 13 sends an instant message containing a text “A taxi has been arranged.” and indicating the pickup point, the pickup time, the drop-off point, and the drop-off time to both the terminal 11 of the user U1 and the terminal 12 of the user U2.

In step S126, the controller 21 of the communication device 20 corresponding to the terminal 11 of the user U1 receives via the communication unit 23 the instant message sent in step S125. The controller 21 displays the received instant message on the screen via the output unit 26.

In this example, the controller 21 of the terminal 11 receives from the SNS server 13 an instant message containing the text “A taxi has been arranged.” and indicating the pickup point, the pickup time, the drop-off point, and the drop time. The controller 21 of the terminal 11 displays the received instant message to the user U1.

In step S127, the controller 21 of the communication device 20 corresponding to the terminal 12 of the user U2 receives via the communication unit 23 the instant message sent in step S125. The controller 21 displays the received instant message on the screen via the output unit 26.

In this example, the controller 21 of the terminal 12 receives from the SNS server 13 an instant message containing the text “A taxi has been arranged.” and indicating the pickup point, the pickup time, the drop-off point, and the drop-off time. The controller 21 of the terminal 12 displays the received instant message to the user U2.

As described above, in the present embodiment, the controller 31 of the control device 30 determines to dispatch the vehicle 15 to transport at least one of a plurality of users according to one or more instant messages sent or received between or among the plurality of users. In the examples of FIGS. 6 to 8, the controller 31 of the SNS server 13 determines to dispatch the vehicle 15 to transport the user U1 according to the two instant messages sent or received between the user U1 and the user U2. The number of users may be three or more. The controller 31 of the control device 30 may determine to dispatch a vehicle or vehicles to transport two or more users.

According to the present embodiment, the convenience of the vehicle dispatch service is improved.

In the present embodiment, the controller 31 of the control device 30 obtains location information of at least one user and determines a pickup point, which is a point where the vehicle 15 picks the at least one user up, based on the location information of the at least one user. In the example of FIGS. 6 to 8, the controller 31 of the SNS server 13 obtains the location information P1 of the user U1 and determines a pickup point, which is a point where the vehicle 15 picks the user U1 up, based on the location information P1 of the user U1. The pickup point is not limited to the point where the user U1 is located, but may be near the point where the user U1 is located, within walking distance of the point where the user U1 is located, or other point. The controller 41 of the vehicle dispatch server 14 or the controller 51 of the vehicle 15 may determine the pickup point.

According to the present embodiment, the convenience of the vehicle dispatch service is further improved.

As a modification of the present embodiment, in the case where the point indicated by location information of at least one user is different from a pickup point, the controller 31 of the control device 30 may instruct the at least one user to move to the pickup point. For example, in the case where the point indicated by the location information P1 of the user U1 is different from a pickup point, the controller 31 of the SNS server 13 may send an instant message instructing the user U1 to move to the pickup point to the terminal 11 of the user U1 and display the instant message on the terminal 11 of the user U1.

According to this modification, the vehicle 15 can be dispatched even when the user U1 is located at a point where it is difficult for the vehicle 15 to pick the user U1 up.

As a modification of the present embodiment, the controller 31 of the control device 30 may determine a route for the vehicle 15 which includes a pickup point as a waypoint. For example, the controller 31 of the SNS server 13 may determine a route for the vehicle 15 which includes a pickup point as a waypoint. The controller 41 of the vehicle dispatch server 14 or the controller 51 of the vehicle 15 may determine a route for the vehicle 15.

According to this modification, the convenience of the vehicle dispatch service is further improved.

In the present embodiment, the controller 31 of the control device 30 obtains location information of at least one user from an instant message sent by at least one user. In the example of FIGS. 6 to 8, the controller 31 of the SNS server 13 obtains the location information P1 of the user U1 from the instant message sent by the user U1.

According to the present embodiment, instant messages can be used effectively.

As a modification of the present embodiment, the controller 31 of the control device 30 may obtain location information of two or more of a plurality of users and determine based on the location information of each user whether the two or more users are transported together by the vehicle 15 or separately transported by the vehicle 15 and one or more other vehicles 15. For example, it is assumed that the user U1, the user U2, and a user U3 are sending instant messages to each other to chat on SNS. The controller 31 of the SNS server 13 may obtain the location information P1 of the user U1 and the location information P2 of the user U2 and determine based on the location information of each user U1, U2 whether the user U1 and the user U2 are transported together by the vehicle 15 or separately transported by the vehicle 15 and another vehicle 15. Specifically, when the distance between the point indicated by the location information P1 of the user U1 and the point indicated by the location information P2 of the user U2 is smaller than a threshold, the controller 31 of the SNS server 13 may determine that the user U1 and the user U2 are transported together by the vehicle 15. When the distance between the point indicated by the location information P1 of the user U1 and the point indicated by the location information P2 of the user U2 is equal to or larger than the threshold, the controller 31 of the SNS server 13 may determine that the user U1 and the user U2 are separately transported by the vehicle 15 and another vehicle 15. The controller 41 of the vehicle dispatch server 14 or the controller 51 of the vehicle 15 may make the same determination.

According to this modification, efficiency of the vehicle dispatch service is improved.

In this modification, in the case where two or more users are going to be transported together by the vehicle 15, the controller 31 of the control device 30 may determine a pickup point, which is a point where the vehicle 15 picks each user up, based on the location information of each user.

In this modification, in the case where the point indicated by the location information of each user is different from the pickup point, the controller 31 of the control device 30 may instruct each user to move to the pickup point.

In this modification, in the case where there are a plurality of pickup points, the controller 31 of the control device 30 may obtain location information of the vehicle 15 and determine, based on the location information of the vehicle 15, a route for the vehicle 15 which includes one of the plurality of points as the first waypoint. For example, in the case where there are a pickup point for the user U1 and a pickup point for the user U2, the controller 31 of the SNS server 13 may determine a route for the vehicle 15 which includes the pickup point closest to the current location of the vehicle 15 as the first waypoint. The controller 41 of the vehicle dispatch server 14 or the controller 51 of the vehicle 15 may determine a route for the vehicle 15.

According to this modification, the convenience and efficiency of the vehicle dispatch service are further improved.

In this modification, the controller 31 of the control device 30 may obtain location information of the vehicle 15 and determine, based on the location information of the vehicle 15 together with the location information of each user, whether two or more users are transported together by the vehicle 15 or separately transported by the vehicle 15 and one or more other vehicles 15.

In this modification, the controller 31 of the control device 30 may obtain location information of each user from an instant message sent by each user.

In the present embodiment, the controller 31 of the control device 30 determines a drop-off point, which is a point where the vehicle 15 drops off at least one user, according to one or more instant messages sent or received between or among a plurality of users. In the examples of FIGS. 6 to 8, the controller 31 of the SNS server 13 determines a drop-off point, which is a point where the vehicle 15 drops off the user U1, according to the two instant messages sent or received between the user U1 and the user U2. The drop-off point is not limited to the point where the user U2 is located, but may be near the point where the user U2 is located, within walking distance of the point where the user U2 is located, or other point. The drop-off point may be determined according to information such as the name of a place mentioned in the two instant messages sent or received between the user U1 and the user U2. The controller 41 of the vehicle dispatch server 14 or the controller 51 of the vehicle 15 may determine the drop-off point.

According to the present embodiment, the convenience of the vehicle dispatch service is further improved.

In the present embodiment, the controller 31 of the control device 30 analyzes the content of one or more instant messages sent or received between or among a plurality of users and determines whether a first user, who is at least one of the plurality of users, is going to visit a second user, who is another user of the plurality of users different from the first user. In the case where the first user is going to visit the second, the controller 31 of the control device 30 obtains location information of the second user and determines a drop-off point based on the location information of the second user. In the examples of FIGS. 6 to 8, the user U1 corresponds to the first user and the user U2 corresponds to the second user, or vice versa.

As a modification of the present embodiment, in the case where the point indicated by the location information of the second user is different from a drop-off point, the controller 31 of the control device 30 may instruct the first user to move from the drop-off point. For example, in the case where the point indicated by the location information P2 of the user U2 is different from a drop-off point, the controller 31 of the SNS server 13 may send an instant message instructing the user U1 to move from the drop-off point to the terminal 11 of the user U1 and display the instant message on the terminal 11 of the user U1.

According to this modification, the vehicle 15 can be dispatched even when the user U2 is located at a point where it is difficult for the vehicle 15 to drop the user U1 off.

As a modification of the present embodiment, the controller 31 of the control device 30 may determine a route for the vehicle 15 which includes a drop-off point as a destination.

In the present embodiment, the controller 31 of the control device 30 analyzes the content of one or more instant messages sent or received between or among a plurality of users and determines whether the vehicle 15 needs to be dispatched. In the case where the controller 31 of the control device 30 determines that the vehicle 15 needs to be dispatched, the controller 31 determines to dispatch the vehicle 15.

According to the present embodiment, the convenience of the vehicle dispatch service is further improved.

In the present embodiment, the controller 31 of the control device 30 sends an instant message inquiring about dispatch of the vehicle 15 to at least one user and receives a request from at least one user. In the examples of FIGS. 6 to 8, the controller 31 of the SNS server 13 sends an instant message inquiring about the location of the user U1 to the user U1 and receives a request from the user U1 regarding a pickup point.

According to the present embodiment, the convenience of the vehicle dispatch service is further improved.

In the present embodiment, the controller 21 of the communication device 20 performs control to display one or more instant messages sent or received between or among a plurality of users and notifies of dispatch of the vehicle 15 that transports at least one of the plurality of users, which has been determined according to the one or more instant messages. In the examples of FIGS. 6 to 8, each of the controller 21 of the terminal 11 and the controller 21 of the terminal 12 performs control to display the two instant messages sent or received between the user U1 and the user U2 and notifies of dispatch of the vehicle 15 that transports the user U1, which has been determined according to the two instant messages. The number of users may be three or more. Dispatch of the vehicle(s) that transports two or more users may be determined.

According to the present embodiment, the convenience of the vehicle dispatch service is improved.

In the present embodiment, the controller 21 of the communication device 20 performs control to display an instant message notifying of dispatch of the vehicle 15 following one or more instant messages sent or received between or among a plurality of users. In the example of FIGS. 6 to 8, each of the controller 21 of the terminal 11 and the controller 21 of the terminal 12 performs control to display the instant message containing the text “A taxi has been arranged.” and indicating the pickup point, the pickup time, the drop-off point, and the drop-off time, following the two instant messages sent or received between the user U1 and the user U2.

According to the present embodiment, the convenience of the vehicle dispatch service is further improved.

The present disclosure is not limited to the above embodiments. For example, a plurality of blocks illustrated in any of the block diagrams may be integrated or one block may be divided into a plurality of blocks. Instead of performing the plurality of steps shown in the flowchart in chronological order according to the description, the steps may be performed in parallel or in a different order either according to the processing capability of the device that performs each step or as necessary. Further modifications can be made without departing from the spirit and scope of the present disclosure.

What is claimed is:

1. A control device, comprising
a controller configured to determine to dispatch a vehicle to transport at least one user of a plurality of users in accordance with one or more instant messages sent or received between or among the plurality of users.

2. The control device according to claim 1, wherein
the controller is configured to obtain location information of the at least one user and is configured to determine, based on the location information of the at least one user, a pickup point, the pickup point being a point where the vehicle picks the at least one user up.

3. The control device according to claim 2, wherein
the controller is configured such that, when a point indicated by the location information of the at least one user is different from the pickup point, the controller instructs the at least one user to move to the pickup point.

4. The control device according to claim 2, wherein
the controller is configured to determine a route for the vehicle, the route including the pickup point as a waypoint.

5. The control device according to claim 2, wherein
the controller is configured to obtain the location information of the at least one user from an instant message sent by the at least one user.

6. The control device according to claim 1, wherein
the controller is configured to obtain location information of two or more users of the plurality of users, and is configured to determine, based on the location information of the two or more users of the plurality of users, whether the two or more users are transported together by the vehicle or separately transported by the vehicle and one or more other vehicles.

7. The control device according to claim 6, wherein
the controller is configured such that, when the two or more users are going to be transported together by the vehicle, the controller determines, based on the location information of each of the two or more users, a pickup point, the pickup point being a point where the vehicle picks each of the two or more users up.

8. The control device according to claim 7, wherein
the controller is configured such that, when a point indicated by the location information of each of the two or more users is different from the pickup point, the controller instructs each of the two or more users to move to the pickup point.

9. The control device according to claim 7, wherein
the controller is configured such that, when there are a plurality of pickup points, the controller obtains location information of the vehicle and determines, based on the location information of the vehicle, a route for the vehicle, the route including one of the plurality of pickup points as a first waypoint.

10. The control device according to claim 6, wherein
the controller is configured to obtain location information of the vehicle and to determine, based on the location information of the vehicle as well as the location information of each of the two or more users, whether the two or more users are transported together by the vehicle or separately transported by the vehicle and one or more other vehicles.

11. The control device according to claim 6, wherein
the controller is configured to obtain the location information of each of the two or more users from an instant message sent by each of the two or more users.

12. The control device according to claim 1, wherein
the controller is configured to determine a drop-off point, the drop-off point being a point where the vehicle drops off the at least one user, in accordance with the one or more instant messages.

13. The control device according to claim 12, wherein
the controller is configured such that the controller analyzes content of the one or more instant messages and determines whether a first user, the first user being the at least one user, is going to visit a second user, the second user being a user included in the plurality of users, the second user being different from the first user, and in a case where the first user is going to visit the second user, the controller obtains location information of the second user and determines the drop-off point based on the location information of the second user.

14. The control device according to claim 13, wherein
the controller is configured such that, when a point indicated by the location information of the second user is different from the drop-off point, the controller instructs the first user to move from the drop-off point.

15. The control device according to claim 12, wherein
the controller is configured to determine a route for the vehicle, the route including the drop-off point as a destination.

16. The control device according to claim 1, wherein
the controller is configured such that the controller analyzes the content of the one or more instant messages and determines whether the vehicle needs to be dispatched, and when the controller determines that the vehicle needs to be dispatched, the controller determines to dispatch the vehicle.

17. The control device according to claim 1, wherein
the controller is configured to send an instant message inquiring about dispatch of the vehicle to the at least one user and receive a request from the at least one user.

18. A communication device, comprising
a controller configured to perform control to display one or more instant messages sent or received between or among a plurality of users and notify of dispatch of a vehicle, the vehicle transporting at least one user of the plurality of users, the dispatch of the vehicle being determined in accordance with the one or more instant messages.

19. The communication device according to claim 18, wherein
the controller is configured to perform control to display an instant message notifying of the dispatch of the vehicle, following the one or more instant messages.

20. A non-transitory storage medium storing a communication program that is executable by one or more processors and that causes the one or more processors to perform functions comprising:
performing control to cause a computer to display one or more instant messages sent or received between or among a plurality of users; and
notifying of dispatch of a vehicle, the vehicle transporting at least one user of the plurality of users, the dispatch of the vehicle being determined in accordance with the one or more instant messages.
